(19) United States
(12) Patent Application Publication
(10) Pub. No.: US 2009/0125662 A1
(43) Pub. Date: May 14, 2009

(54) Switch having integrated connectors

(75) Inventor: Cheng-ping Shih, Pingchien City (TW)

Correspondence Address: COOPER & DUNHAM, LLP, 30 Rockefeller Plaza, 20th Floor, NEW YORK, NY, 10112, US

(73) Assignee: J-Three International Holding Co., Ltd.

(21) Appl. No.: 11/983,542

(22) Filed: Nov. 9, 2007

(51) Int. Cl. G06F 13/00

(52) U.S. Cl. 710/304

(57) ABSTRACT

A switch having integrated connectors for connecting to computers has a casing, multiple peripheral ports, at least two integrated connectors and a switch unit. The peripheral ports are mounted on the casing and are for connecting respectively to multiple corresponding peripheral devices. Each integrated connector is a peripheral component interconnect express type connector and is for connecting one-to-one to a corresponding computer. The switch unit is mounted in the casing and is connected between the integrated connectors and the peripheral ports to allow a user to select one computer to be connected to the peripheral devices at a time.

### BACKGROUND OF THE INVENTION

1. Field of the Invention

The present invention relates to a switch, and more particularly to a switch having integrated connectors for connecting respectively to multiple computers.

2. Description of Related Art

A keyboard video mouse (KVM) switch allows a single keyboard, monitor and mouse to be connected to multiple computers to allow a user to interact with the computers from the keyboard, monitor and mouse. The user activates the switch to select which only computer they interact with. The KVM switch may also allow the user to share universal serial bus devices and audio devices with multiple computers.

With reference to FIG. 4, the switch (70) comprises multiple connection ports (71A, 71B, 71C) and multiple connecting modules (80). Each connecting module (80) has multiple connectors (81, 82, 83) being a video connector (81), a keyboard connector (82) and a mouse connector (83).

However, to connect the computer to the switch, each connector (81, 82, 83) must be plugged into the computer at great inconvenience to the user.

To overcome the shortcomings, the present invention provides a switch having integrated connectors for connecting respectively to computers to mitigate or obviate the aforementioned problems.

### SUMMARY OF THE INVENTION

The main objective of the invention is to provide a switch having integrated connectors for connecting to computers.

The switch in accordance with the present invention comprises a casing, multiple peripheral ports, at least two integrated connectors and a switch unit. The peripheral ports are mounted on the casing and are for connecting respectively to multiple corresponding peripheral devices. Each integrated connector is a peripheral component interconnect express type connector and is for connecting one-to-one to a corresponding computer. The switch unit is mounted in the casing and is connected between the integrated connectors and the peripheral ports to allow a user to select one computer to be connected to the peripheral devices at a time.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a switch in accordance with the present invention;

FIG. 2 is a perspective view of an integrated connector in FIG. 1 and a corresponding peripheral component interconnect express (PCI E) slot of a notebook;

FIG. 3 is a functional block diagram of the switch in FIG. 1 connecting a monitor, a keyboard and a mouse to two notebooks; and

FIG. 4 is a perspective view of a conventional switch.

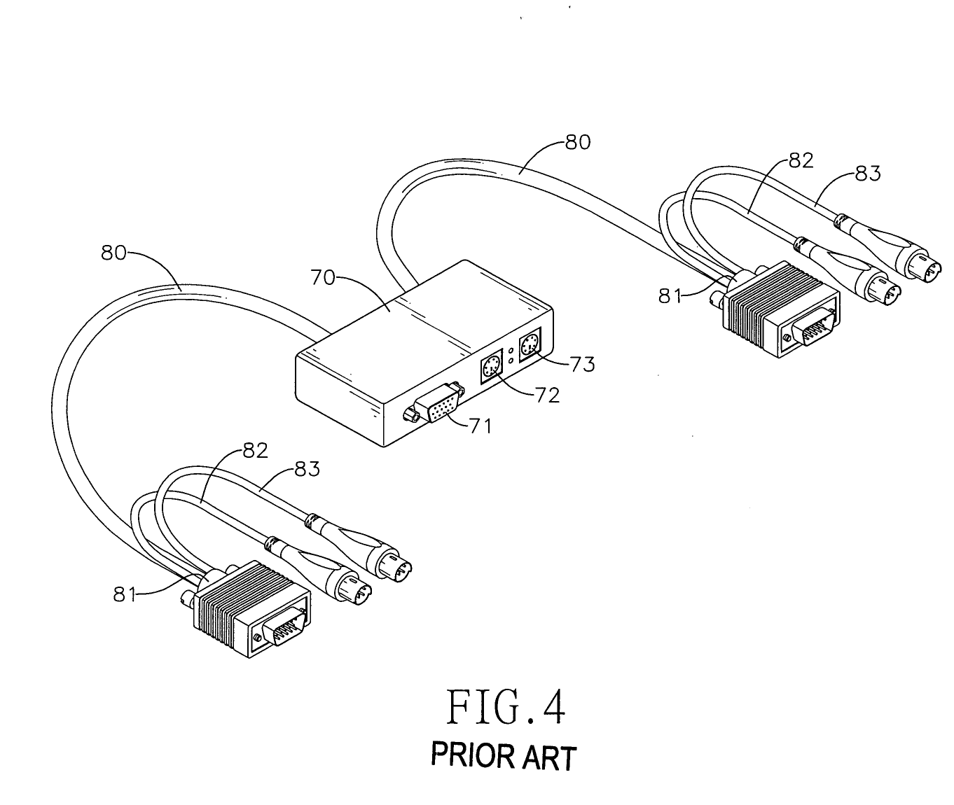

### DETAILED DESCRIPTION OF PREFERRED EMBODIMENT

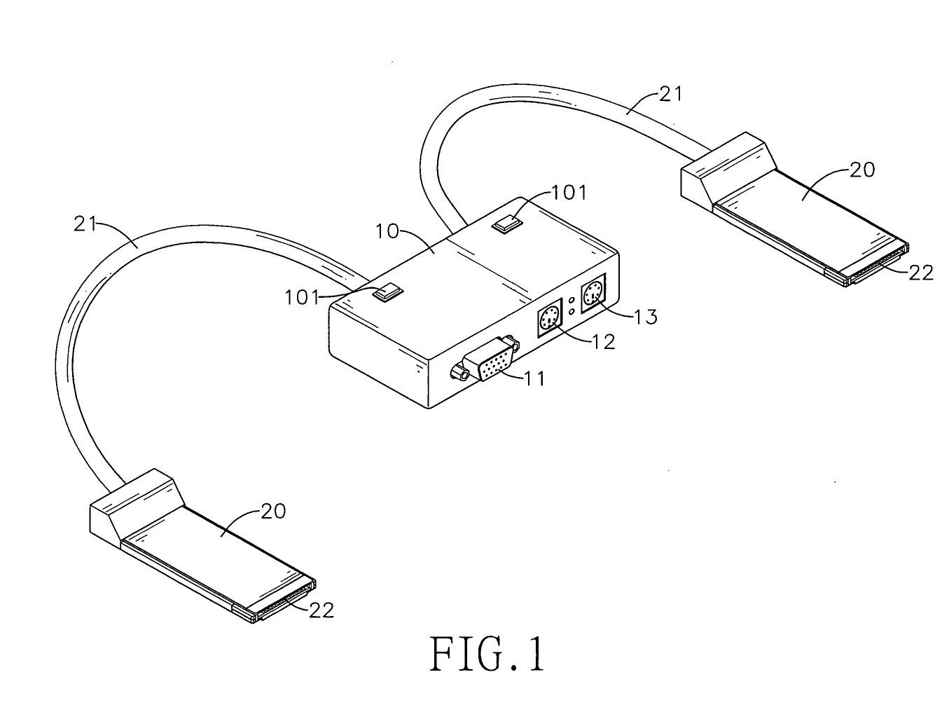

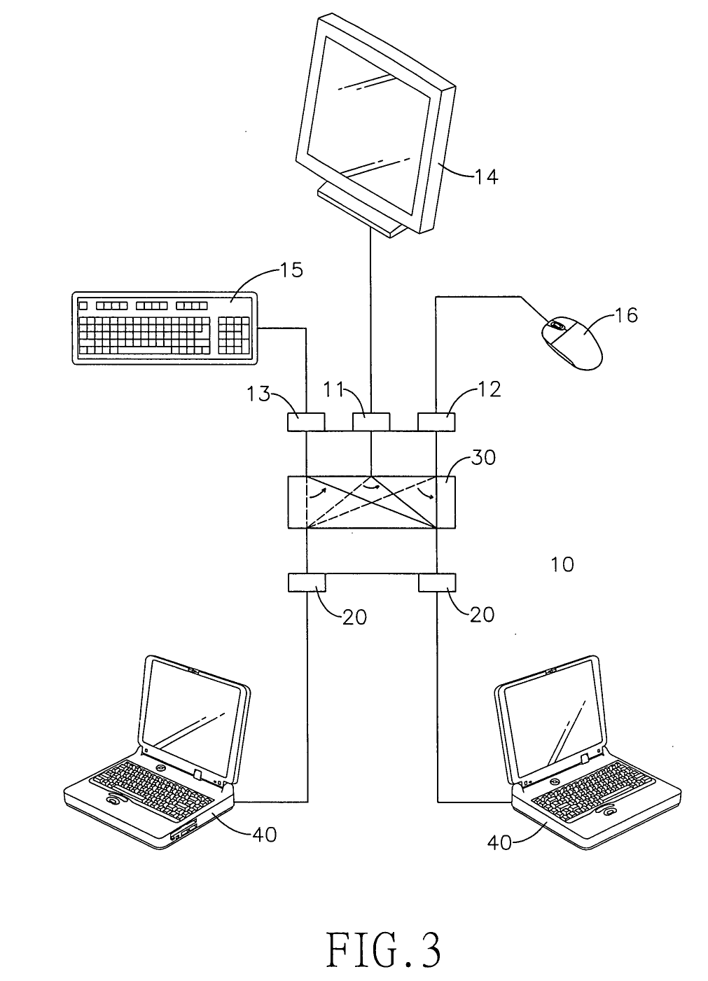

With reference to FIGS. 1 and 3, a switch in accordance with the present invention comprises a casing (10), an optional switching element, multiple peripheral ports (11, 12, 13), at least two integrated connectors (20) and a switch unit (30).

The switching element is mounted on the casing (10) to allow the user to operate the switch and may comprise at least two buttons (101).

Each peripheral port (11, 12, 13) is mounted on the casing (10) for connecting to a corresponding peripheral device. The peripheral ports (11, 12, 13) may be a video outputting port (11), a keyboard inputting port (12), a mouse inputting port (13), an audio outputting port, an universal serial bus (USB) port, 1394 high speed serial bus or the like and allows a monitor (14), keyboard (15), mouse (16), peripheries and the like to be connected.

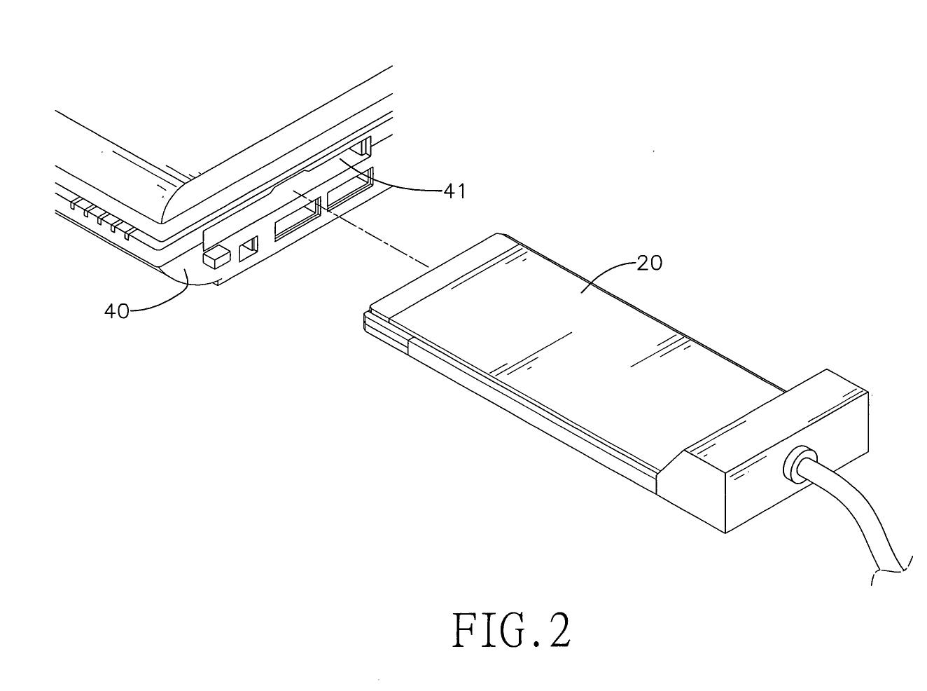

With further reference to FIG. 2, the integrated connectors (20) are connected to the casing (10) with wires (21) and may correspond respectively to the buttons (101). Each integrated connector (20) is a peripheral component interconnect express (PCI E) type connector, may have multiple pins (21) and is for connecting one-to-one to a corresponding computer having a PCI E slot (41).

The pins (22) are mounted in and extend outward from the integrated connector (20) and have multiple definitions corresponding respectively to the pins (22) for transferring data between the peripheral devices and the computer connected to the peripheral devices. Furthermore, the definitions of the pins (22) may not the same as the pin definitions of an original PCI E connector so the integrated connectors (20) is a PCI E type connector with different definitions of pins (22).

The switch unit (30) may be an electronic switch unit, is mounted in the casing (10) and is connected to the switching element and between the integrated connectors (20) and the peripheral ports (11, 12, 13) to allow the user to select one computer to be connected to the peripheral devices at a time by operating the switching element.

The integrated connectors (20) of the present invention connect one-to-one to the computers because the pins (21) in each integrated connector (20) have their own specific definitions for transferring data between the computers and the peripheral devices. Accordingly, the switch in accordance with the present invention requires fewer connectors than a conventional switch. Therefore, the switch of the present invention is easier and more convenient to use than the conventional switch.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A switch having integrated connectors for connecting to computers comprising:
a casing;
multiple peripheral ports being mounted on the casing and for connecting respectively to multiple corresponding peripheral devices;
at least two integrated connectors being connected to the casing with wires, and each integrated connector being a peripheral component interconnect express type connector and being for connecting one-to-one to a corresponding computer; and
a switch unit being mounted in the casing and being connected between the integrated connectors and the peripheral ports to select one computer to be connected to the peripheral devices at a time.

2. The switch as claimed in claim 1, wherein each integrated connector further has multiple pins being mounted in and extending outward from the integrated connector and having multiple definitions corresponding respectively to the pins for transferring data between the peripheral devices and the computer connected to the peripheral devices.

3. The switch as claimed in claim 1 further comprising a switching element being mounted on the casing to operate the switch to select one computer to be connected to the peripheral devices at a time.

4. The switch as claimed in claim 2 further comprising a switching element being mounted on the casing to operate the switch to select one computer to be connected to the peripheral devices at a time.

5. The switch as claimed in claim 3, wherein the switching element comprises at least two buttons mounted on the casing, corresponding respectively to the at least two integrated connectors and connected to the switch unit.

6. The switch as claimed in claim 4, wherein the switching element comprises at least two buttons mounted on the casing, corresponding respectively to the at least two integrated connectors and connected to the switch unit.

7. The switch as claimed in claim 5, wherein the switch unit is an electronic switch unit.

8. The switch as claimed in claim 6, wherein the switch unit is an electronic switch unit.
